(19) United States
(12) Patent Application Publication
(10) Pub. No.: US 2019/0366603 A1
(43) Pub. Date: Dec. 5, 2019

(54) METAL AND PLASTIC COMPOSITE MATERIAL AND METHOD FOR MAKING SAME

(71) Applicants: SHENZHEN FUTAIHONG PRECISION INDUSTRY CO., LTD., Shenzhen (CN); FIH (HONG KONG) LIMITED, Kowloon (HK)

(72) Inventors: CHWAN-HWA CHIANG, New Taipei (TW); CHEN-YI TAI, New Taipei (TW); ZENG-MAO ZHENG, Shenzhen (CN)

(21) Appl. No.: 16/177,383

(22) Filed: Oct. 31, 2018

(30) Foreign Application Priority Data
May 31, 2018 (CN) 201810552682.5

(51) Int. Cl. B29C 45/14; C23F 1/26; B32B 15/08

(52) U.S. Cl. CPC B29C 45/14311; C23F 1/26; B29K 2101/12; B29C 2045/14868; B32B 15/08

(57) ABSTRACT

A composite material includes a metal substrate, and a plastic member formed on a surface of the metal substrate. A material of the metal substrate is titanium or titanium alloys, and an acid treatment leaves nano-holes and protrusions on the surface of the metal substrate. The composite material further includes a combining layer between the metal substrate and the plastic member. The nano-holes are partially filled with the combining layer, the protrusions are partially surrounded by the combining layer. The disclosure further provides a method for making such composite material.

### FIELD

The subject matter herein generally relates to composite material.

### BACKGROUND

Most metal and plastic composites on the market use electrochemical methods to form nano-holes on the surface of metal substrates, and then through injection molding with plastic to form composite material. However, due to the nature of the metal, electric sparks can be generated during the processes of electrochemical treatment, and the conventional composite material of metal and plastic may not be stable. Improvement in the art is preferred.

### BRIEF DESCRIPTION OF THE DRAWINGS

Embodiments of the present disclosure will now be described, with reference to the attached figures.

FIG. 1 is a cross-sectional view of an embodiment of a composite material.

FIG. 2 is a partial cross-sectional view of a portion of the composite material in FIG. 1.

FIG. 3 is a flow chart of a method for making a composite material in accordance with an embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiment described herein can be practiced without these specific details. In other instances, methods, procedures, and components have not been described in detail so as not to obscure the related relevant feature being described. Further, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series, and the like.

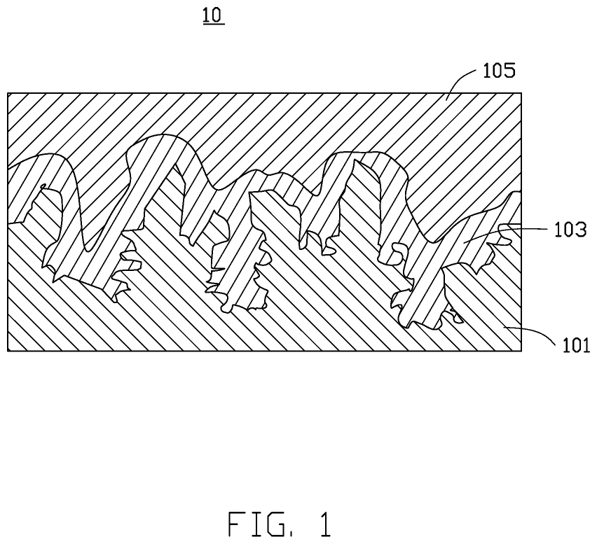

FIG. 1 illustrates an embodiment of a composite material 10.

The composite material 10 includes a metal substrate 101, a combining layer 103, and a plastic member 105.

A material of the metal substrate 101 can be titanium or titanium alloys. The titanium alloys can be selected from a group consisting of TAD, TA0, TA1, TA2, TA3, TA4, TA5, TA6, TA7, TA9, TA10, TB2, TB3, TB4, TC1, TC2, TC3, TC4, TC6, TC9, TC10, TC11, and TC12.

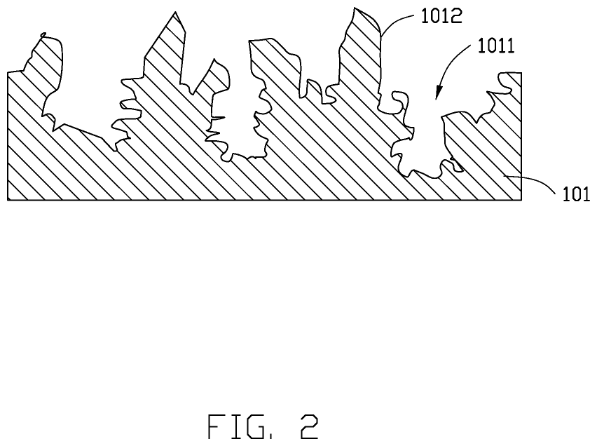

Referring to FIG. 2, nano-holes 1011 are formed on a surface of the metal substrate 101 in the present embodiment. The nano-holes 1011 are irregular cavities, diameters of the nano-holes 1011 vary in a range from several tens of manometers to several hundreds of nanometers. Shapes of the nano-holes 1011 are substantially like those in a honeycomb.

Referring to FIG. 2, irregular protrusions 1012 accompany the nano-holes 1011. The protrusions 1012 can be formed beside the nano-holes 1011, or in the nano-holes 1011 or at any other portions of the metal substrate 101. The protrusions 1012 are portions of the metal substrate 101.

In the present embodiment, the nano-holes 1011 and the protrusions 1012 are formed on the metal substrate 101 by acid treatment. Specifically, immersing the metal substrate 101 into a pickling solution at 15-45° C. for 2-30 minutes. The pickling solution includes 4-22% by weight of acid solution, 0.7-2.8% by weight of additive, 0.6-3.7% by weight of hydrogen peroxide, and 76-94% by weight of pure water. The acid solution is one or more of acetic acid, formic acid, oxalic acid, hydrofluoric acid, and sulfamic acid. The additive is one or more of potassium fluoride, sodium fluoride, magnesium fluoride, and copper sulfate.

The combining layer 103 is formed on the surface of the metal substrate 101 by surface treatment. The surface of the metal substrate 101 includes the surface of the nano-holes 1011 and the surface of the protrusions 1012. The acid treated metal substrate 101 is put into a surface treating agent for surface treatment at 15-50° C. for 1-3 minutes to form the combining layer 103 on the surface of the metal substrate 101. In the present embodiment, the nano-holes 1011 are partially filled with the surface treating agent. The combining layer 103 has a thickness of 1-200 nanometers.

In one embodiment, the surface treating agent is hydrolysate, including silane coupling agent and solvent. In the surface treatment, hydrolysable groups in the silane coupling agent are hydrolyzed in the solvent to form silanol bonds. The silanol bonds react with the metal substrate 101 so that the combining layer 103 is firmly formed on the surface of the metal substrate 101. The silane coupling agent can be selected from a group consisting of 2-(3,4-epoxy cyclohexyl) ethyl trimethoxy silane, 3-(3,4-epoxy cyclohexyl) propyl trimethoxy silane, and 4-(3,4-epoxy cyclohexyl) butyl trimethoxy silane. The solvent can be selected from one of ethyl alcohol and water.

The plastic member 105 is formed on the combining layer 103 by injection molding process. In the present embodiment, portions of the nano-holes 1011 which are not filled with the combining layer 103 are filled with the plastic member 105. The plastic member 105 is crystalline thermoplastic. The crystalline thermoplastic can be selected from a group consisting of polyamide, polyphenylene sulfide, polybutylene terephthalate, polycarbonate, and polyvinyl chloride.

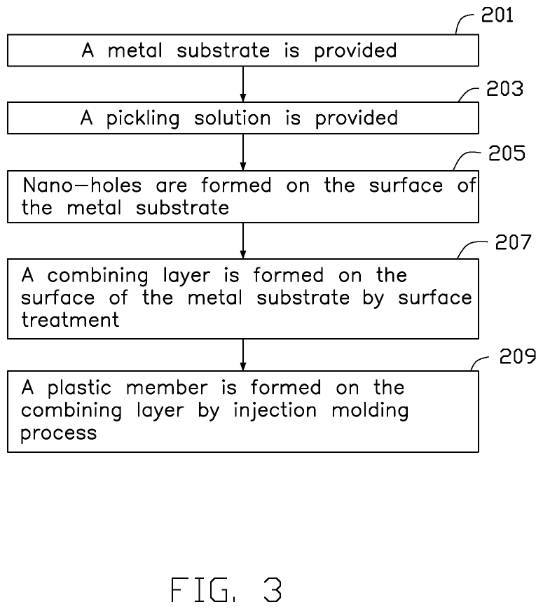

Referring to FIG. 3, the present disclosure discloses a method for making the composite material 10, which is described as follows:

At block 201, a metal substrate 101 is provided. A material of the metal substrate 101 can be titanium or titanium alloys. The titanium alloys can be selected from a group consisting of TAD, TA0, TA1, TA2, TA3, TA4, TA5, TA6, TA7, TA9, TA10, TB2, TB3, TB4, TC1, TC2, TC3, TC4, TC6, TC9, TC10, TC11, and TC12.

The metal substrate 101 is cleaned. In the present embodiment, the cleaning process includes dipping the metal substrate 101 in a degreasing solution, and then removing the metal substrate 101 from the degreasing solution and rinsing with pure water to remove dust and oil on the surface of the metal substrate 101.

At block 203, a pickling solution is provided. In the present embodiment, the pickling solution includes 4-22% by weight of acid solution, 0.7-2.8% by weight of additive, 0.6-3.7% by weight of hydrogen peroxide and 76-94% by weight of pure water. The acid solution is one or more of acetic acid, formic acid, oxalic acid, hydrofluoric acid, and sulfamic acid. The additive is one or more of potassium fluoride, sodium fluoride, magnesium fluoride, and copper sulfate.

At block 205, nano-holes 1011 are formed on the surface of the metal substrate 101. In the present embodiment, the nano-holes 1011 are formed on the metal substrate 101 by acid treatment. Specifically, immersing the metal substrate 101 into the pickling solution at 15-45° C. for 2-30 minutes to form the nano-holes 1011 on the surface of the metal substrate 101. The nano-holes 1011 are irregular cavities, diameters of the nano-holes 1011 vary in a range from several tens of nanometers to several hundreds of nanometers. Shapes of the nano-holes 1011 are substantially like those in a honeycomb.

Further, irregular protrusions 1012 accompany the nano-holes 1011. The protrusions 1012 can be formed beside the nano-holes 1011, or in the nano-holes 1011 or at any other portions of the metal substrate 101. The protrusions 1012 are portions of the metal substrate 101.

The acid treated metal substrate 101 is washed by rinsing the surface of the metal substrate 101 with pure water to remove the pickling solution.

At block 207, a combining layer 103 is formed on the surface of the metal substrate 101 by surface treatment. The surface of the metal substrate 101 includes the surface of the nano-holes 1011 and the surface of the protrusions 1012.

The surface treatment comprises immersing the metal substrate 101 into a surface treating agent for surface treatment at 15-50° C. for 1-3 minutes to form the combining layer 103 on the surface of the metal substrate 101. In the present embodiment, the nano-holes 1011 are partially filled with the surface treating agent. The combining layer 103 has a thickness of 1-200 nanometers.

In one embodiment, the surface treating agent is hydrolysate, including silane coupling agent and solvent. In the surface treatment, hydrolysable groups in the silane coupling agent are hydrolyzed in the solvent to form silanol bonds. The silanol bonds react with the metal substrate 101 so that the combining layer 103 is firmly formed on the surface of the metal substrate 101. The silane coupling agent can be selected from a group consisting of 2-(3,4-epoxy cyclohexyl) ethyl trimethoxy silane, 3-(3,4-epoxy cyclohexyl) propyl trimethoxy silane, and 4-(3,4-epoxy cyclohexyl) butyl trimethoxy silane. The solvent can be selected from one of ethyl alcohol and water.

The metal substrate 101 with the combining layer 103 is washed by rinsing the surface treated metal substrate 101 with pure water to remove the surface treating agent.

At block 209, a plastic member 105 is formed on the combining layer 103 by injection molding process. In the present embodiment, the injection molding process includes putting the metal substrate 101 with the combining layer 103 into an injection molding mold, injecting molten injection molding plastic into the injection molding mold, so that the injection molding plastic covers the combining layer 103. The injection molding plastic is hardened to obtain the composite material 10 in which the metal substrate 101 and the plastic member 105 are combined. The plastic member 105 is crystalline thermoplastic. The crystalline thermoplastic can be polyamide, polyphenylene sulfide, polybutylene terephthalate, polycarbonate, polyvinyl chloride or other common injection molding plastics for precision injection.

In the present embodiment, portions of the nano-holes 1011 which are not filled with the combining layer 103 are filled with the plastic member 105 to enhance a bonding force between the plastic member 105 and the metal substrate 101. Furthermore, since the composition of the combining layer 103 is the surface treating agent, organic functional groups such as hydroxyl groups, carboxyl groups, amino groups, or epoxy groups in the surface treating agent bond chemically with reactive functional groups in the plastic member 105 to produce very strong bond. The chemical bond force further enhances the binding force of the plastic member 105 and the metal substrate 101.

Embodiments according to the present disclosure are described below.

### Embodiment 1

The metal substrate 101 is made of titanium alloy.

The metal substrate 101 is cleaned. Specifically, dipping the metal substrate 101 into a degreasing solution at 45° C. for 2 minutes, then removing the metal substrate 101 from the degreasing solution and rinsing with water to remove dust and oil.

A pickling solution is provided. The pickling solution includes 4% by weight of sulfamic acid, 1% by weight of formic acid, 1% by weight of potassium fluoride, 2% by weight of hydrogen peroxide, and 92% by weight of pure water.

Nano-holes 1011 are formed on the surface of the metal substrate 101. Specifically, immersing the metal substrate 101 into the pickling solution, and pickled at room temperature for 16 minutes to form the nano-holes 1011 on the surface of the metal substrate 101.

The metal substrate 101 with the nano-holes 1011 is washed by rinsing the surface of the metal substrate 101 with pure water to remove the pickling solution.

A combining layer 103 is formed on the surface of the metal substrate 101 with the nano-holes 1011 by surface treatment. The surface treatment comprises immersing the metal substrate 101 into a surface treating agent for surface treatment at room temperature for 3 minutes to form the combining layer 103 on the surface of the metal substrate 101. In the present embodiment, the nano-holes 1011 are partially filled with the surface treating agent.

The metal substrate 101 having the combining layer 103 is washed by rinsing the surface treated metal substrate 101 with pure water to remove the surface treating agent.

A plastic member 105 is formed on the combining layer 103 by injection molding process. In the present embodiment, the injection molding process comprises putting the metal substrate 101 having the combining layer 103 into an injection molding mold, injecting molten polyphenylene sulfide resin into the injection molding mold, so that the polyphenylene sulfide resin covers the surface of the combining layer 103. The polyphenylene sulfide resin is hardened to obtain the composite material 10 in which the metal substrate 101 and the plastic member 105 are combined. In the present embodiment, portions of the nano-holes 1011 which are not filled with the combining layer 103 are filled with the polyphenylene sulfide resin.

Test Results:

Tensile test: The composite material 10 is tested using a universal material testing machine, and the combined strength of 0.5 cm² combined area is 1300-1600 N.

### Embodiment 2

The metal substrate 101 is made of titanium alloy.

The metal substrate 101 is cleaned. Specifically, dipping the metal substrate 101 into a degreasing solution at 45° C. for 2 minutes, then removing the metal substrate 101 from the degreasing solution and rinsing with water to remove dust and oil covered.

A pickling solution is provided. The pickling solution includes 5% by weight of acetic acid, 1.5% by weight of oxalic acid, 1.2% by weight of sodium fluoride, 2% by weight of hydrogen peroxide and 90.3% by weight of pure water.

Nano-holes 1011 are formed on the surface of the metal substrate 101. Specifically, immersing the metal substrate 101 into the pickling solution, and pickled at room temperature for 10 minutes to form the nano-holes 1011 on the surface of the metal substrate 101.

The metal substrate 101 with the nano-holes 1011 is washed by rinsing the surface of the metal substrate 101 with pure water to remove the pickling solution.

A combining layer 103 is formed on the surface of the metal substrate 101 with the nano-holes 1011 by surface treatment. The surface treatment comprises immersing the metal substrate 101 into a surface treating agent for surface treatment at room temperature for 3 minutes to form the combining layer 103 on the surface of the metal substrate 101. In the present embodiment, the nano-holes 1011 are partially filled with the surface treating agent.

The metal substrate 101 having the combining layer 103 is washed by rinsing the surface of the metal substrate 101 with pure water to remove the surface treating agent.

A plastic member 105 is formed on the combining layer 103 by injection molding process. In the present embodiment, the injection molding process comprises putting the metal substrate 101 having the combining layer 103 into an injection molding mold, injecting molten polyamide resin into the injection molding mold, so that the polyamide resin covers the surface of the combining layer 103. The polyamide resin is hardened to obtain the composite material 10 in which the metal substrate 101 and the plastic member 105 are combined. In the present embodiment, portions of the nano-holes 1011 which are not filled with the combining layer 103 are filled with the polyamide resin.

Test Results:

Tensile test: The composite material 10 is tested using a universal material testing machine, the combined strength of 0.5 cm² combined area is 1400-1700 N.

The bonding force of the composite material 10 improved by forming the nano-holes 1011 and the protrusions 1012 on the surface of the metal substrate 101. The nano-holes 1011 are irregular cavities. Shapes of the nano-holes 1011 are substantially like those in a honeycomb. A combining layer 103 formed between the metal substrate 101 and the plastic member 105 further enhances the bonding force. The operations provided by the embodiments can be easily carried out. A high temperature environment is not needed to carry out the processes, so metal and plastic composites may be manufactured in a safer environment.

It is to be understood, however, that even through numerous characteristics and advantages of the present disclosure have been set forth in the foregoing description, together with details of assembly and function, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A composite material comprising:
a metal substrate, a material of the metal substrate is selected from one of titanium and titanium alloys, nano-holes being formed on a surface of the metal substrate;
a combining layer formed on the metal substrate, the nano-holes partially filled with the combining layer; and
a plastic member formed on the combining layer.

2. The composite material of claim 1, wherein the nano-holes are irregular cavities, and diameters of the nano-holes vary in a range from several tens of nanometers to several hundreds of nanometers.

3. The composite material of claim 2, wherein shapes of nano-holes are substantially like those in a honeycomb.

4. The composite material of claim 2, wherein protrusions accompany the nano-holes, the protrusions are formed beside the nano-holes.

5. The composite material of claim 2, wherein protrusions accompany the nano-holes, the protrusions are formed in the nano-holes.

6. The composite material of claim 2, wherein protrusions accompany the nano-holes, the protrusions are formed at portions of the metal substrate other than the nano-holes and the protrusions.

7. The composite material of claim 1, wherein the titanium alloys are selected from a group consisting of TAD, TA0, TA1, TA2, TA3, TA4, TA5, TA6, TA7, TA9, TA10, TB2, TB3, TB4, TC1, TC2, TC3, TC4, TC6, TC9, TC10, TC11, and TC12.

8. The composite material of claim 1, wherein portions of the nano-holes which are not filled with the combining layer are filled with the plastic member.

9. A method for making a composite material comprising:
providing a substrate, a material of the metal substrate is selected from one of titanium and titanium alloys;
forming nano-holes on a surface of the metal substrate by acid treatment;
forming a combining layer on the metal substrate by surface treatment, and partially filling the nano-holes with the combining layer; and
forming a plastic member on the combining layer.

10. The method of claim 9, wherein the acid treatment comprises treating the surface of the metal substrate with a pickling solution, the pickling solution comprises 4-22% by weight of acid solution, 0.7-2.8% by weight of additive, 0.6-3.7% by weight of hydrogen peroxide, and 76-94% by weight of pure water.

11. The method of claim 10, wherein the acid solution comprises one or more of acetic acid, formic acid, oxalic acid, hydrofluoric acid, and sulfamic acid; the additive comprises one or more of potassium fluoride, sodium fluoride, magnesium fluoride, and copper sulfate.

12. The method of claim 9, wherein the surface treatment comprises treating the metal substrate having the nano-holes with a surface treating agent for 0.1 to 3 minutes, and forming the combining layer further comprises partially filling the nano-holes with the surface treating agent.

13. The method of claim 9, wherein shapes of nano-holes are substantially like those in a honeycomb.

14. The method of claim 13, wherein protrusions accompany the nano-holes, the protrusions are formed beside the nano-holes.

15. The method of claim 13, wherein protrusions accompany the nano-holes, the protrusions are formed in the nano-holes.

16. The method of claim 13, wherein protrusions accompany the nano-holes, the protrusions are formed at portions of the metal substrate other than the nano-holes and the protrusions.
